(19) United States
(12) Patent Application Publication
(10) Pub. No.: US 2007/0223726 A1
(43) Pub. Date: Sep. 27, 2007

(54) Universal cassette bridge

(76) Inventor: Chance Dunn, Livermore, CA (US)

Correspondence Address: John Nielsen;RANDICK O'DEA & TOOLIATOS, LLP, 5000 HOPYARD ROAD, SUITE 400, PLEASANTON, CA, 94588, US

(21) Appl. No.: 11/387,576

(22) Filed: Mar. 22, 2006

(51) Int. Cl. H04B 1/00

(52) U.S. Cl. 381/86

(57) ABSTRACT

The invention described herein generally describes a mounting apparatus for portable electronic devices (hereinafter “PED”). More particularly, the present invention relates to a cassette adapter coupled to a mounting bracket and PED holder that allows the user to use and store their PED, particularly in a motor vehicle.

### BACKGROUND OF THE INVENTION

A. Field of the Invention

The invention disclosed herein relates generally to a mounting apparatus for portable electronic devices (hereinafter “PED”). More particularly, the present invention relates to a cassette adapter coupled to a mounting bracket and PED holder that allows the user to use and store their PED, particularly in a motor vehicle.

B. Description of the Prior Art

The use of cassette adapters is well known. The Schotz invention U.S. Pat. No. 4,734,897 describes a cassette adapter that comprises a cassette, as well as an attached wire from the cassette that can be plugged into another audio source (e.g. the PED). However, this invention, and others like it, suffer from the limitation that no safe and convenient method or apparatus is provided for holding and storing the PED during use. Utilizing these types of devices, especially in automobiles, requires the user to either position the PED somewhere in the interior of the vehicle on an ad hoc basis, or install a separate mounting device.

There are also several mounting devices for automobile electronics. For example, Benedeti invention U.S. Pat. No. 5,813,583 provides a portable CD holder that can be screwed into the underside of the dashboard. This requires that the dashboard of the vehicle be permanently altered, along with the associated risks and expenses. The Sokol invention U.S. Pat. No. 4,648,572 patent utilizes a suction cup device intended to attach to the front windshield of the vehicle to support a radar detector device. Such a device has limitations including negative aesthetic characteristics, it may limit the view of the driver, and it may eventually lose its adhesion to the surface of the windshield.

### SUMMARY OF THE INVENTION

Given the rapid advance of audio technology that now includes the use of digital audio sources, many people no longer access music via the standard sized cassette tape. However, many automobiles still have cassette players in the dashboard. As discussed above, cassette adapters that allow PEDs to access the automobile's audio system have existed for some time. These adapters utilize a cassette player to reproduce the sounds generated by other devices, such as a portable electronic device, such as an mp3 player, Ipod, cell phones, satellite radio, PDAs, or other audio source. If such other devices include a simple headphone jack, the present invention facilitates such use.

As discussed above, mounting a mobile device inside an automobile is usually inconvenient. The limited space of the automobile is already utilized by the car stereo and other in-dash items that make the mounting of additional devices inconvenient. The invention described herein allows for the mounting of any appropriately sized electronic device in a convenient place to reach without obstructing the driver's viewing area.

In accordance with this invention, an adapter is provided for enabling the signals produced by another audio source to be reproduced as audio sounds by a cassette player audio system of the type having a cassette playback deck. The adapter includes a housing of a configuration that is substantially identical to the configuration of a cassette normally used with the playback deck. As used herein, the expression “cassette” is intended to refer to conventional reel-to-reel magnetic tape cassettes, such as the so-called “standard” type cassette.

As in known cassette adapters, the housing of the adapter of the present invention has at least one opening to receive at least one reel-drive spindle of the cassette playback deck, and a record head supported in the housing in a position for contacting the playback head normally provided in the playback deck. An electrical conductor, such as a dual lead conductor, is coupled at one end to a plug that is compatible with the usual headphone jack of the other sound producing device and is connected at its other end through an audio circuit to the record head. When the adapter is loaded into the cassette playback deck and that deck as well as the other device both are operated, signals produced by the other device are coupled, by means of the aforementioned conductor and audio circuit, to the record head from which those signals are applied to the playback head of the cassette playback deck and, thence, those signals are reproduced by the audio system.

The present invention includes a bracket that is attached to a cassette adapter. The bracket is shaped and configured such that the cassette adapter can remain in the vehicle's cassette player during use, while the bracket projects outward from the cassette adapter and cassette player. At the other end of the bracket is a means to hold a PED for use as an audio source for the vehicle's audio system. In one embodiment, the means to hold the PED comprises a clip or similar arrangement that allows the user to attach the PED to the cassette adapter wire, while also being capable of holding the PED during use. Another embodiment comprises a relatively flat surface of the bracket portion facing the driver that can include a Velcro or similar substance. Using this configuration, Velcro can then be placed on the back of the PED. This configuration will allow the user to easily attach the PED to the bracket by pressing the PED against the bracket face. the user will then be in a position to easily plug the cassette adapter wire into the headphone jack (or other audio output means).

Once the cassette adapter is placed in the cassette player, and the cassette adapter wire is plugged into the PED, the user is then in a position to use the PED as the audio source of the vehicle's audio system. The above described device and configuration allows the user to easily, safely, and conveniently access their PED while in their automobile. Since most cassette players in motor vehicles are designed to play standard sized cassettes, the preferred embodiment of the invention utilizes a standard sized cassette, however any size cassette could be used.

### BRIEF DESCRIPTION OF THE DRAWINGS

FIG. 1 is a perspective view of an embodiment of the invention.

FIG. 2 is a side view of the invention shown in FIG. 1.

FIG. 3 is a perspective view of an embodiment of the invention with the cassette portion within a in-dash cassette player, with a detached PED.

FIG. 4 is a perspective view of an embodiment of the invention with the cassette portion within an in-dash cassette player, with a attached PED.

### DETAILED DESCRIPTION OF THE DRAWINGS

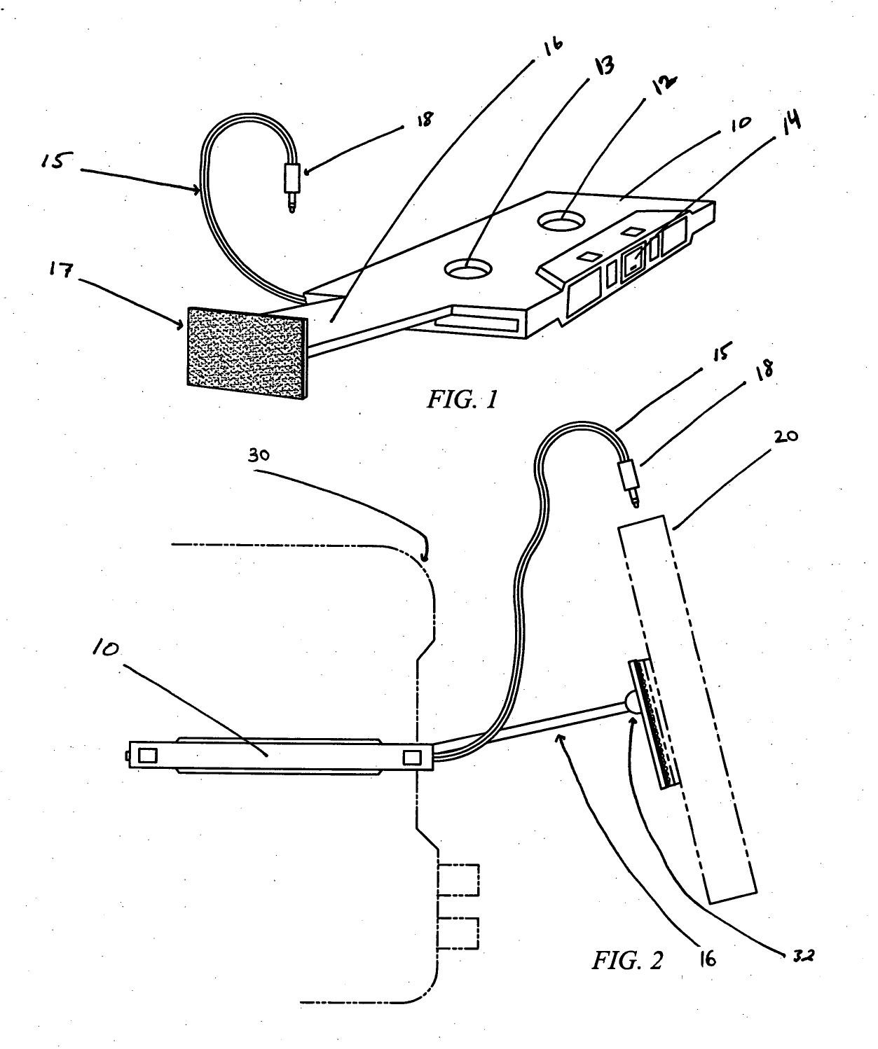

FIG. 1 is a perspective view of an embodiment of the invention. The cassette adapter 10 is a conventional audio cassette adapter of a type readily available from various manufacturers, and comprises a housing 18 and openings 12, 13, 14 such that the cassette adapter is capable of fitting and functioning in a standard sized audio cassette player. In the preferred embodiment, the cassette adapter 10 is intended for use with a cassette deck player and, thus, the housing is shown in the familiar configuration of a conventional (or standard) reel-to-reel, magnetic tape cassette. The cassette adapter 10 includes a pair of openings 12, 13 that extend through the housing, and are adapted to receive the conventional reel-drive spindles provided in the usual cassette playback deck when the cassette adapter is loaded into the cassette deck. The figure also shows a record head 14 supported in the housing in a position for contacting the playback head normally provided in the playback deck.

The adapter wire(s) (hereinafter ‘adapter wire’), 15, is an electrical conductor that comprises a plurality of wires. This adapter wire 15 is connected at one end to the cassette in such a way as to be connected to permit electrical signals from a connected PED to play through the vehicle's audio system. The other end of the adapter wire 15 comprises a plug 18. This plug 18 is a conventional stereophonic plug 18 of a type readily available from various manufacturers. The plug 18 may comprise a generally straight plug 18 (as shown), or a “dog leg” 90 degree angle plug, or any other similar configuration. The adapter wire 15 is flexible so as to be movable, and allows the user to manually place the plug 18 into an output jack (e.g. the headphone jack) of a PED.

Attached to the cassette adapter 10 is a bridge or bracket 16 that extends out from the side of the cassette adapter 10, such that the bracket extends out from the cassette player when the cassette adapter 10 is placed in the cassette player of the automobile. The bracket 16 may be made from a variety of different materials, including but not limited to metal and/or plastic. In one embodiment, the bracket 16 is rigid, while in other embodiments, the bracket 16 is flexible. The bracket 16 can be affixed to the cassette adapter 10 in a variety of ways, including the use of adhesive, or a mechanical attachment, such as with a physical coupling of the cassette and bracket. The bracket 16 can also be integrated into the cassette such that it comprises an extension of the cassette, and can be made from the same material as the cassette housing. The bracket 16 is configured such as to allow it to extend from the cassette adapter 10 while it is engaged and functioning within the cassette player.

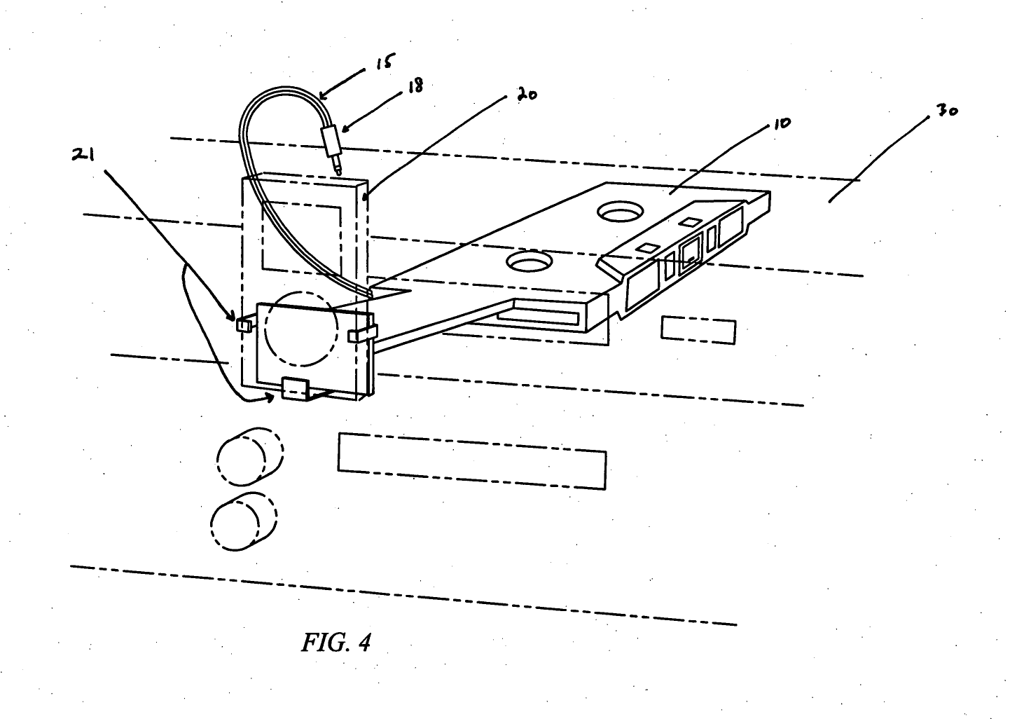

FIG. 1 also shows a holding plate 17 attached to the end of the bracket 16. In one embodiment, this holding plate can comprise a relatively flat rigid surface with a Velcro (or the like) surface facing outward from the cassette adapter. If the user places Velcro or the like on the back of their PED, this configuration would allow the user to easily affix their PED 20 onto the holding plate 17, as well as easily remove it. In other configurations, such as in FIG. 4, the user can place the PED 20 within a clip apparatus, located at the end of the bracket, that supports the PED 20 from both sides and the bottom. In a preferred embodiment, the clip apparatus will allow the PED 20 to remain open and unfettered on top, which will allow the user to easily access the adapter wire and plug it into the headphone or other audio output jack of the PED 20, which is typically located on top of the PED 20.

FIG. 2 is a side view of an embodiment of the invention. In this figure, the cassette portion of the cassette adapter 10 is shown within the cassette player, which is located within the dashboard of the vehicle. The bracket 16 is attached to, and extends outwards from, the cassette adapter 10. The adapter wire 15 also extends out from the cassette, and is shown in a position where it would normally be plugged into the audio output jack, typically located on top of the PED 20, through the use of the plug 18. In one embodiment, a hinge 32 is located at the junction of the bracket 16 and the holding plate 17. This allows the user to adjust the angle of the PED 20 when in use. The hinge 32 element can be included in a variety of different embodiments, including those using a clip or basket arrangement. FIG. 2 illustrates an embodiment of the invention where the PED 20 has been secured to the holding plate 17 of the apparatus.

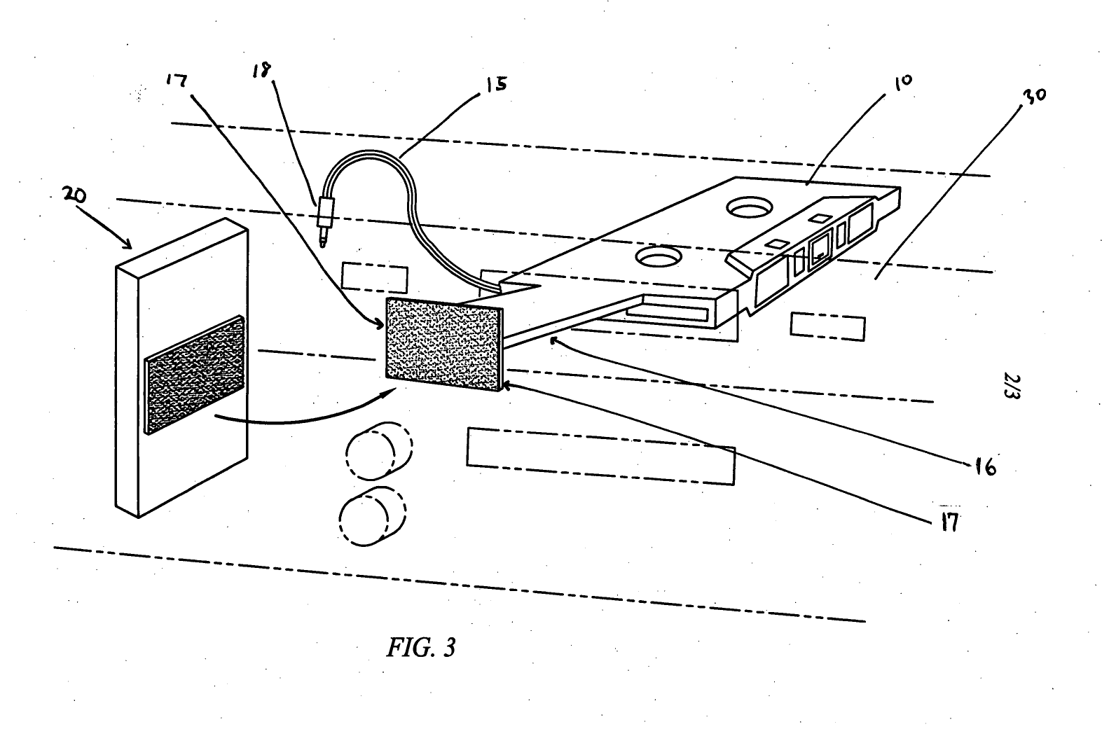

FIG. 3 is a perspective view of an embodiment of the invention. In this embodiment, the cassette portion of the apparatus has been lodged into a cassette player, while the bracket 16 and adapter wire 15 extend out from the cassette. This figure illustrates an embodiment utilizing the holding plate 17 at the end of the bracket 16. A Velcro or similar type material is shown on the forward facing portion of the holding plate 17. The figure shows a similarly sized strip of Velcro or similar type material on the back of the PED 20. This configuration allows the user to simply press the PED 20 against the holding plate to secure it. In this embodiment, the cassette player is located in the dashboard of an automobile. After the PED 20 has been secured to the apparatus in this fashion, the PED 20 will be can be easily accessed by a user located in the front seat of the automobile. The length of the adapter wire 15 and the size of the plug 18 are such that the plug 18 can be inserted into the output jack of the PED 20, for instance into the headphone jack of the PED 20.

FIG. 4 is a perspective view of an embodiment of the invention with the cassette portion within an in-dash cassette player, with an attached PED 20. As in FIG. 3, in this embodiment, the cassette portion of the apparatus has been lodged into a cassette player, while the bracket 16 and adapter wire 15 extend out from the cassette. This figure illustrates an embodiment utilizing a clip 21 (or basket) arrangement for holding the PED 20. In the embodiment shown, clips 21 extend from the two sides and the bottom of the holding plate 17, on the side of the holding plate farthest from the cassette adapter 10. In the configuration shown, the ends of the clips 21 located on the sides of the holding plate are angled at approximately 90 degrees from the portion of the clip extending from the holding plate, this bend in the clip angling towards the middle of the holding plate 17. Similarly, the clip 21 supporting the bottom of the PED 20 is angled up at the end. These bends in the clips 21 assist in securing the PED 20 when placed within the confines of the apparatus.

Alternative embodiments include a basket arrangement on the end of the bracket 16 capable of supporting and securing a PED 20. Such an embodiment is preferably open on top to facilitate easy placement and removal of the PED 20, as well as facilitate easy plugging in and unplugging of the PED 20.

What is claimed:

1. An apparatus for use in a motor vehicle comprising:
a. An adapter device for transferring audio signals from a Portable Electronic
Device (PED) to a cassette player, wherein said adapter device is capable of insertion into a cassette player, and wherein the adapter device is further capable of utilizing the output of the PED to play on said motor vehicle's audio system;
b. A bracket attached to the cassette adapter extending out from the cassette; and
c. A means to secure the PED to the bracket.

2. The apparatus of claim 1, wherein said apparatus is located generally in front of the audio controls of the vehicle's dashboard during use.

3. The apparatus of claim 1, wherein the bracket extends out from the cassette in a generally coplanar arrangement.

4. The apparatus of claim 1, further comprising an adapter wire attached on one end to the record head of the cassette and capable of transferring signals produced by the PED to the playback head of the cassette player.

5. The apparatus of claim 1 or 2, wherein the bracket portion comprises a flexible material that allows for various cassette tape player configurations.

6. The apparatus of claim 1 or 2, wherein the bracket portion comprises a flexible material that allows the user to adjust the location of the PED.

7. The apparatus of claim 1, wherein the means to hold the PED comprise a basket attached to the end of the mounting bracket.

8. The apparatus of claim 7, wherein the basket arrangement is capable of supporting and securing a PED.

9. The apparatus of claim 1, wherein the means to hold the PED comprise a generally flat member, said flat member is generally perpendicular to the mounting bracket.

10. The apparatus of claim 9, wherein the generally flat member further comprises a Velcro, or the like, material.

11. The apparatus of claim 1 or 2, wherein the PED holder is open on top.

12. The apparatus of claim 1 or 2, wherein the size and shape of the PED holder is adjustable.

13. The apparatus of claim 1 or 2, further comprising a hinge located at the junction of the bracket and the means for securing the PED.

14. The apparatus of claim 9, further comprising a hinge located at the junction of the bracket and the flat member.

15. The apparatus of claim 7, further comprising a hinge located at the junction of the bracket and the basket.
